(19) United States
(12) Patent Application Publication
(10) Pub. No.: US 2024/0359351 A1
(43) Pub. Date: Oct. 31, 2024

(54) CONNECTING STRUCTURE OF PRESSING PLATE IN FOOD CUTTER

(71) Applicant: SHUANGMA PLASTIC MANUFACTURING INC., Taizhou (CN)

(72) Inventor: Cuihong CHEN, Taizhou (CN)

(21) Appl. No.: 18/514,554

(22) Filed: Nov. 20, 2023

(30) Foreign Application Priority Data
Apr. 25, 2023 (CN) 202320969397.X

(51) Int. Cl. B26D 1/08

(52) U.S. Cl. CPC B26D 1/08; B26D 2210/02

(57) ABSTRACT

The utility model provides a domestic food cutterbar, it includes: go up casing, lower casing, support column, clamp plate and chopping disk, last casing top be provided with first through-hole, the support column mobilizablely run through the setting and be in first through-hole in, the top of support column be provided with the clamp plate, the bottom of support column be provided with the chopping disk, last casing top with clamp plate bottom between the support column on the cover be equipped with reset spring, last casing lower part periphery upwards be provided with the external screwthread, lower casing top in upwards be provided with in week with the internal thread that is screw thread looks adaptation, last casing with lower casing threaded connection. The utility model has the advantages that the whole structure is simple single, can be simply quick cut food, the food after the cutting is put neatly, has still avoided food juice to outflow, has ensured food hygiene, has improved consumer's use experience.

### CROSS REFERENCE TO RELATED APPLICATIONS

This application claims foreign priority of Chinese Patent Application No. 202320969397. X, filed on Apr. 25, 2023 in the China National Intellectual Property Administration, the disclosures of all of which are hereby incorporated by reference.

### TECHNICAL FIELD

The present application relates to the technical field of a food cutter, and in particular to a connecting structure of a pressing pate in the food cutter.

### BACKGROUND OF THE PRESENT INVENTION

At present, when cooking food, people often need to cut the food into pieces. In order to improve efficiency of cutting vegetables, many cutting tools appear on the market, mostly by scraping the food with people's hands. Such way of cutting vegetables has certain risks and is easy to scratch people's fingers. Moreover, because the smaller the remaining food is, the easier the people get hurt when cutting vegetables, people will choose to discard some food, resulting in unnecessary waste. Therefore, a manual vegetable cutter, appearing on the market, fixes a cutting blade, and then presses potatoes and other things need to be cut into pieces against the cutting blade through a pressing plate. With facing requirements of different sizes and shapes, many kinds of cutting blades are provided, and a user needs to replace the cutting blades according to needs thereof when using the food cutter. For the pressing plate, in order to completely cut the food, a lower end of the pressing plate is usually detachably provided with a bump matched with the cutter inside the cutting blade, and the bump is inserted between the cutters, so that the food is completely removed from the cutter. In the prior art, the bump of the vegetable cutter and the pressing plate are basically pressed to fit, that is, the bump is directly pressed into the pressing plate, and the bump is prevented from falling through the press-fitting of the bump and the pressing plate, but the user often changes a shape of the cutting blade in an actual use process, so that the bump also needs to be changed correspondingly, and the bump fixed through press-fitting is extremely inconvenient to change.

### SUMMARY OF PRESENT INVENTION

In view of the shortcomings in the prior art, the application aims at providing a connecting structure of a pressing plate in a food cutter, which has the advantage of facilitating a user to replace a material pressing block.

The above technical purpose of the application is realized by a technical solution as follow: comprising a material pressing block (2) and a pressing plate (3), wherein a lower end of the material pressing block (2) is provided with two or more material pressing bulges (4), a lower plate surface of the pressing plate (3) is provided with a connecting portion I (5), an upper end of the material pressing block (2) is provided with a connecting portion II (6), and the connecting portion I (5) and the connecting portion II (6) are rotationally fixed or clamped with each other.

According to the above technical solution, when the user needs to replace the cutting tool, the material pressing block needs to be replaced at the same time after the cutting tool is replaced, and in the process of replacing the material pressing block, dismounting between the pressing plate and the material pressing block is easier through cooperation between the connecting portion I and the connecting portion II, which is convenient for the user to operate.

Preferably, the connecting portion I comprises a limiting groove I provided on the lower plate surface of the pressing plate, a groove wall of the limiting groove I is provided with two or more limiting blocks I, the connecting portion II comprises a limiting bump I arranged on the upper end of the material pressing block, a side wall of the limiting bump I is provided with two or more limiting bumps II, the limiting bump I is capable of being inserted into the limiting groove I and is rotationally matched with the limiting groove I; and the limiting block I is matched with the limiting block II to limit the limiting bump I from pulling away from the limiting groove I.

Preferably, the lower plate surface of the pressing plate is provided with two or more positioning grooves, the upper end of the pressing block is provided with a plurality of positioning bulges corresponding to positions of the positioning grooves one by one, and the positioning bulges are capable of being clamped into the positioning grooves.

Preferably, the connecting portion I comprises a limiting groove II provided on the lower plate surface of the pressing plate, the connecting portion II comprises a limiting bump II arranged at the upper end of the material pressing block, and the limiting groove II is in threaded connection with the limiting bump II.

Preferably, a side wall of the material pressing block extends outwards to form a limiting plate, and a lower end surface of the limiting plate is capable of being attached to an upper end surface of a cutting tool.

Preferably, a position of a blade in the cutting tool is lower than the upper end surface of the cutting tool.

Preferably, a chamfer is formed between an upper end surface of the pressing plate and a side wall of the pressing plate.

Preferably, further comprising a protective sleeve and an accommodating barrel, wherein the protective sleeve is mounted between the material pressing block and the pressing plate, and the protective sleeve is capable of being sleeved in the accommodating barrel.

Preferably, the protective sleeve is provided with a plurality of guide recesses, and the accommodating barrel is provided with guide bulges corresponding to the guide recesses one by one.

Preferably, an upper end of the accommodating barrel is provided with a cutting tool mounting groove, and the cutting tool is mounted in the cutting tool mounting groove.

In conclusion, the application has the following beneficial effects compared with the prior art:

1. The dismounting between the pressing plate and the material pressing block is easier through cooperation between the connecting portion I and the connecting portion II, which is convenient for the user to operate.

2. The position of the blade in the cutting tool is lower than the upper end surface of the cutting tool, so that the material pressing block will not press the blade during the pressing process, which effectively prolongs a service life of the blade.

3. Through cooperation of the positioning groove and the positioning bulge, on the one hand, rotation between the material pressing block and the pressing plate will not easily occur, and on the other hand, the user can be prompted whether mounting between the material pressing block and the pressing plate is in place.

### DESCRIPTION OF THE DRAWINGS

FIG. 1 is a schematic diagram of an explosive structure of an embodiment I;

FIG. 2 is a structural schematic diagram of a material pressing block in the embodiment I;

FIG. 3 is a structural schematic diagram of a food cutter in the embodiment I;

FIG. 4 is a structural schematic diagram of an accommodating barrel in the embodiment I; and

FIG. 5 is a structural schematic diagram of a protective sleeve in the embodiment I.

Numeral references: 1 refers to cutting tool; 2 refers to material pressing block; 3 refers to pressing plate; 4 refers to material pressing bulge; 5 refers to connecting portion I; 6 refers to connecting portion II; 7 refers to limiting groove I; 8 refers to limiting block I; 9 refers to limiting bump I; 10 refers to limiting block II; 11 refers to positioning groove; 12 refers to positioning bulge; 13 refers to limiting plate; 14 refers to protective sleeve; 15 refers to accommodating barrel; 16 refers to guide bulge; 17 refers to guide recess; 18 refers to cutting tool mounting groove.

### DETAILED DESCRIPTION OF PREFERRED EMBODIMENTS

The application will be further described in detail in conjunction with the accompanying drawings.

### EMBODIMENT

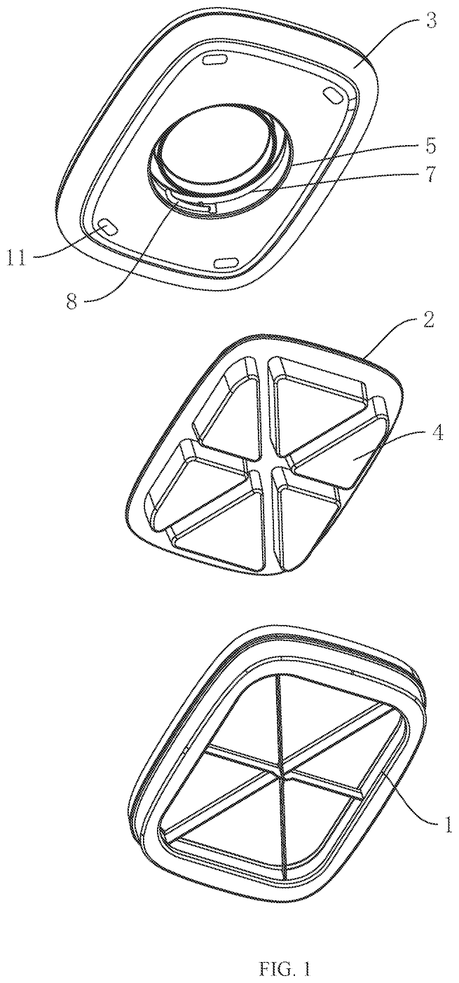

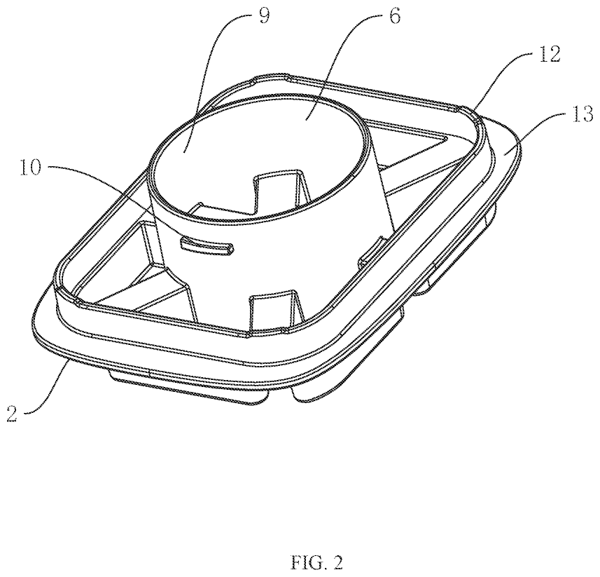

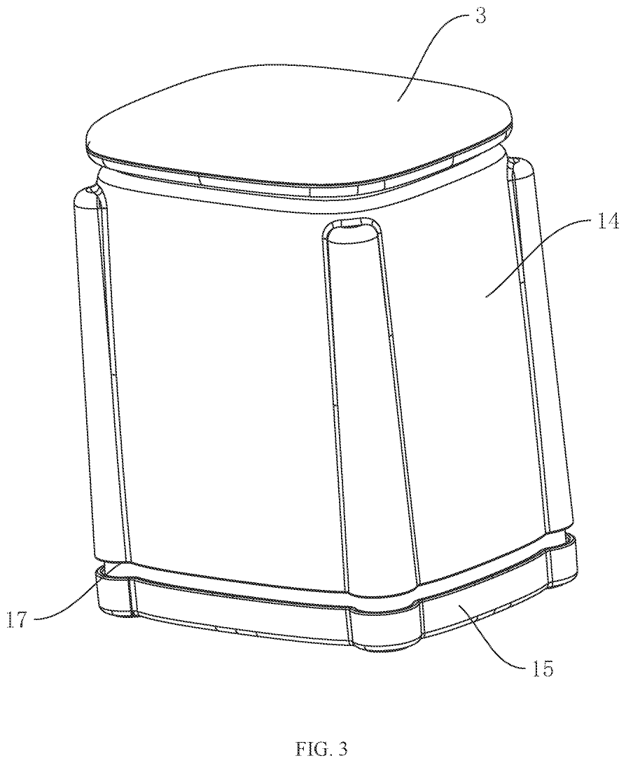

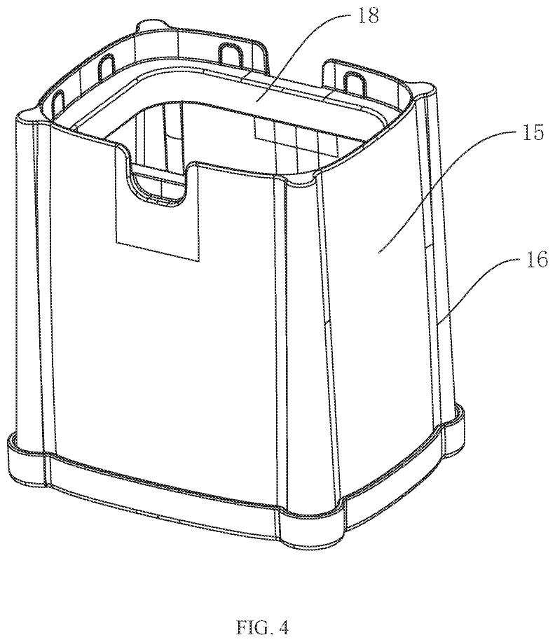

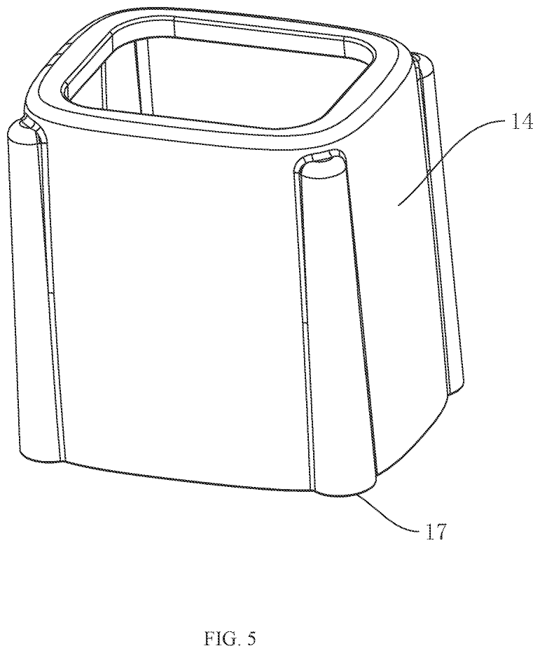

A connecting structure of a pressing plate in a food cutter, as shown in FIG. 1 to FIG. 5, comprises a cutting tool 1, a material pressing block 2 and the pressing plate 3 sequentially arranged from bottom to top, the cutting tool 1 is mounted on an accommodating barrel and a blade of the cutting tool 1 is distributed along a vertical direction. A lower end of the material pressing block 2 is provided with two or more material pressing bulges 4, the material pressing bulges 4 are capable of being pressed into the cutting tool 1. By pressing the material pressing bulges 4 into the cutting tool 1, food may be effectively prevented from sticking to the cutting tool 1 or from being completely cut off. It should be noted that in a set of food cutters, multiple sets of cutting tools 1 need to be provided to cut food into different shapes in consideration of requirements and adaptability of a user for products, and a number of the material pressing blocks 2 matched with the cutting tool should also correspond to a number of the cutting tools 1 one by one.

For fixation between the pressing plate 3 and the material pressing block 2, a lower plate surface of the pressing plate 3 is provided with a connecting portion I 5, an upper end of the material pressing block 2 is provided with a connecting portion II 6, and the connecting portion I 5 and the connecting portion II 6 are rotationally fixed or clamped with each other. The material pressing block 2 is more easily dismounted by the user via a rotationally fixed way.

The connecting portion I 5 comprises a limiting groove I 7 provided on the lower plate surface of the pressing plate 3, a groove wall of the limiting groove I 7 is provided with two or more limiting blocks I 8, two limiting blocks are preferable, the connecting portion II 6 comprises a limiting bump I 9 arranged on the upper end of the material pressing block 2, a side wall of the limiting bump I 9 is provided with two or more limiting blocks II 10, two limiting blocks are preferable, the limiting bump I 9 is capable of being inserted into the limiting groove I 7 and is rotationally matched with the limiting groove I 7; and the limiting block I 8 is matched with the limiting block II 10 to limit the limiting bump I 9 from pulling away from the limiting groove I 7. To be specific, an upper end surface of the limiting block I 8 is pressed with a lower end surface of the limiting block II 10. The limiting block I and the limiting block II are not easily pulled away from each other and are convenient to dismount through the pressing between the limiting block I 8 and the limiting block II 10. As a replacing solution, the limiting block II 10 may also be used for being rotationally inserted into the limiting block I 8 to complete.

The lower plate surface of the pressing plate 3 is provided with two or more positioning grooves 11, four positioning grooves are preferable, the upper end of the pressing block 2 is provided with a plurality of positioning bulges 12 corresponding to positions of the positioning grooves 11 one by one, and the positioning bulges 12 are capable of being clamped into the positioning grooves 11. The material pressing block 2 and the pressing plate 3 are not easily rotated therebetween by fitting of the positioning groove 11 and the positioning bulge 12.

A position of a blade in the cutting tool 1 is lower than the upper end surface of the cutting tool 1, a side wall of the material pressing block 2 extends outwards to form a limiting plate 13, and a lower end surface of the limiting plate 13 is capable of being attached to an upper end surface of a cutting tool 1. The limiting plate 13 is used for limiting a material pressing depth of the material pressing block 2 to prevent the material pressing block 2 from hitting the blade portion of the cutting tool 1.

A chamfer is formed between an upper end surface of the pressing plate 3 and a side wall of the pressing plate 3, thereby effectively preventing a user from being hurt in applying a force to the pressing plate 3.

Moreover, a food cutter is further provided, comprising the connecting structure of the pressing plate in the food cutter, further comprising a protective sleeve 14 and an accommodating barrel 15 for preventing the food from sputtering juice, the protective sleeve 14 is mounted between the material pressing block 2 and the pressing plate 3, the protective sleeve 14 is capable of being sleeved on the accommodating barrel 15, the protective sleeve 14 is provided with a plurality of guide recesses 17, and the accommodating barrel 15 is provided with guide bulges 16 corresponding to the guide recesses 17 one by one.

An upper end of the accommodating barrel 15 is provided with a cutting tool mounting groove 18, and the cutting tool 1 is mounted in the cutting tool mounting groove 18.

Embodiment II: a difference between the embodiment II and the embodiment I is that, the connecting portion I 5 comprises a limiting groove II provided on the lower plate surface of the pressing plate 3, the connecting portion II 6 comprises a limiting bump II arranged at the upper end of the material pressing block 2, and the limiting groove II is in threaded connection with the limiting bump II.

Embodiment III: a difference between the embodiment III and the embodiment I is that, the connecting portion I 5 and the connecting portion II 6 are matched via a buckle, the connecting portion I 5 comprises a limiting groove III provided on the lower surface of the pressing plate 3, a groove wall of the limiting groove III is provided with a clamping groove, the connecting portion II 6 comprises a limiting bump III arranged on the upper end of the pressing block 2, and the side wall of the limiting bump III is provided with clamping blocks corresponding to the clamping grooves one by one and being capable of being clamped into the clamping grooves.

The above is only an exemplary implementation of the application, and is not used to limit the protection scope of the application, and the protection scope of the application is determined by the appended claims.

We claim:

1. A connecting structure of a pressing plate in a food cutter, comprising a material pressing block (2) and a pressing plate (3), wherein a lower end of the material pressing block (2) is provided with two or more material pressing bulges (4), a lower plate surface of the pressing plate (3) is provided with a connecting portion I (5), an upper end of the material pressing block (2) is provided with a connecting portion II (6), and the connecting portion I (5) and the connecting portion II (6) are rotationally fixed or clamped with each other.

2. The connecting structure of the pressing plate in the food cutter according to claim 1, wherein the connecting portion I (5) comprises a limiting groove I (7) provided on the lower plate surface of the pressing plate (3), a groove wall of the limiting groove I (7) is provided with two or more limiting blocks I (8), the connecting portion II (6) comprises a limiting bump I (9) arranged on the upper end of the material pressing block (2), a side wall of the limiting bump I (9) is provided with two or more limiting bumps II (10), the limiting bump I (9) is capable of being inserted into the limiting groove I (7) and is rotationally matched with the limiting groove I (7); and the limiting block I (8) is matched with the limiting block II (10), so as to limit the limiting bump I (9) from pulling away from the limiting groove I (7).

3. The connecting structure of the pressing plate in the food cutter according to claim 2, wherein the lower plate surface of the pressing plate (3) is provided with two or more positioning grooves (11), the upper end of the pressing block (2) is provided with a plurality of positioning bulges (12) corresponding to positions of the positioning grooves (11) one by one, and the positioning bulges (12) are capable of being clamped into the positioning grooves (11).

4. The connecting structure of the pressing plate in the food cutter according to claim 1, wherein the connecting portion I (5) comprises a limiting groove II provided on the lower plate surface of the pressing plate (3), the connecting portion II (6) comprises a limiting bump II arranged at the upper end of the material pressing block (2), and the limiting groove II is in threaded connection with the limiting bump II.

5. The connecting structure of the pressing plate in the food cutter according to claim 2, wherein a side wall of the material pressing block (2) extends outwards to form a limiting plate (13), and a lower end surface of the limiting plate (13) is capable of being attached to an upper end surface of a cutting tool (1).

6. The connecting structure of the pressing plate in the food cutter according to claim 5, wherein a position of a blade in the cutting tool (1) is lower than the upper end surface of the cutting tool (1).

7. The connecting structure of the pressing plate in the food cutter according to claim 6, wherein a chamfer is formed between an upper end surface of the pressing plate (3) and a side wall of the pressing plate (3).

8. A food cutter, comprising the connecting structure of the pressing plate in the food cutter according to claim 1, further comprising a protective sleeve (14) and an accommodating barrel (15), wherein the protective sleeve (14) is mounted between the material pressing block (2) and the pressing plate (3), and the protective sleeve (14) is capable of being sleeved in the accommodating barrel (15).

9. The food cutter according to claim 8, wherein the protective sleeve (14) is provided with a plurality of guide recesses (17), and the accommodating barrel (15) is provided with guide bulges (16) corresponding to the guide recesses (17) one by one.

10. The food cutter according to claim 9, wherein an upper end of the accommodating barrel (15) is provided with a cutting tool mounting groove (18), and the cutting tool (1) is mounted in the cutting tool mounting groove (18).
